(19) United States
(12) Patent Application Publication
(10) Pub. No.: US 2026/0088399 A1
(43) Pub. Date: Mar. 26, 2026

(54) CAMBER-FLOW BATTERY CELLS

(71) Applicant: GM Global Technology Operations LLC, Detroit, MI (US)

(72) Inventors: Alfredo Salituro, Ferndale, MI (US); Seung-Woo Chu, Sterling Heights, MI (US); Mark Daniel Gottlieb, Royal Oak, MI (US); Phillip Daniel Hamelin, Holly, MI (US); Alexander M. Bilinski, Avoca, MI (US)

(73) Assignee: GM Global Technology Operations LLC, Detroit, MI (US)

(21) Appl. No.: 18/891,441

(22) Filed: Sep. 20, 2024

(51) Int. Cl. H01M 50/107; H01M 10/04; H01M 10/613; H01M 10/656; H01M 50/119; H01M 50/152; H01M 50/213; H01M 50/342; H01M 50/474

(52) U.S. Cl. CPC H01M 50/107; H01M 10/0431; H01M 10/0468; H01M 10/613; H01M 10/656; H01M 50/119; H01M 50/152; H01M 50/213; H01M 50/3425; H01M 50/474

(57) ABSTRACT

A camber-flow battery cell includes a metallic enclosure, an electrode assembly, and one or more fin inserts. The metallic enclosure includes a top cap plate, a bottom cap plate, a first side wall, and a second side wall. The first and second side walls form a cambered profile defined by an imaginary chord line and an imaginary camber line, where the imaginary camber line is different from the imaginary chord line. The electrode assembly is disposed within the metallic enclosure and includes a plurality of layers of an electrode material, wherein the plurality of layers of electrode material are formed by at least one of rolling the electrode material or folding the electrode material. Each of the one or more fin inserts is fitted between the electrode assembly and the metallic enclosure to fill a respective space between the electrode assembly and the metallic enclosure.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Battery-powered devices (e.g., electric or hybrid-electric powered vehicles, or electric powered non-vehicular devices) are powered by one or more battery cells. In some instances, it is necessary to cool the battery cell(s) by flowing a fluid or gas around the battery cell(s).

The present disclosure relates generally to battery cells and, more particularly, to camber-flow battery cells having a cambered profile.

### SUMMARY

One aspect of the disclosure provides a camber-flow battery cell including a metallic enclosure, an electrode assembly, and one or more fin inserts. The metallic enclosure includes a top cap plate, a bottom cap plate, a first side wall, and a second side wall, wherein the first and second side walls form a cambered profile defined by an imaginary chord line and an imaginary camber line, the imaginary camber line being different from the imaginary chord line. The electrode assembly is disposed within the metallic enclosure and includes a plurality of layers of an electrode material, wherein the plurality of layers of electrode material are formed by at least one of rolling the electrode material or folding the electrode material. Wherein each of the one or more fin inserts is fitted between the electrode assembly and the metallic enclosure to fill a respective space between the electrode assembly and the metallic enclosure.

Implementations of the disclosure may include one or more of the following optional features. In some implementations, the cambered profile is selected so that the electrode assembly may be substantially uniformly cooled by at least one of a fluid or a gas flowing along the camber-flow battery cell. In some examples, the cambered profile is selected so that the camber-flow battery cell may be nested together with other camber-flow battery cells to form a battery array. In some implementations, the camber-flow battery cell also includes a mandrel, wherein the mandrel has a shape corresponding to the cambered profile and applies a force to the electrode assembly to press the electrode assembly against the first and second side walls. The electrode material may be rolled about the mandrel.

In some examples, the electrode material is folded back and forth on itself. Lengths of folds of the electrode material vary across the electrode assembly. In some implementations, the one or more fin inserts are inserted at respective ends of the metallic enclosure. The one or more fin inserts may be formed from a non-energy-storing thermally conductive material.

In some implementations, the camber-flow battery cell also includes a first cell terminal collector disposed in the electrode assembly, a second cell terminal collector disposed in the electrode assembly, a positive terminal disposed on the top cap plate and electrically connected to the first cell terminal collector, and a negative terminal disposed on the top cap plate and electrically connected to the second cell terminal collector. In some examples, the camber-flow battery cell also includes a vent disposed on at least one of the top cap plate or the bottom cap plate.

Another aspect of the disclosure provides a method for forming a camber-flow battery cell. The method includes forming a metallic enclosure and an electrode assembly. The metallic enclosure includes a top cap plate, a bottom cap plate, a first side wall, and a second side wall, wherein the first and second side walls form a cambered profile defined by an imaginary chord line and an imaginary camber line, the imaginary camber line being different from the imaginary chord line. The electrode assembly is formed by at least one of rolling an electrode material or folding the electrode material. The method also includes inserting one or more fin inserts into the metallic enclosure and inserting the electrode assembly into the metallic enclosure between the one or more fin inserts and the first and second side walls, wherein each of the one or more fin inserts fills a respective space between the electrode assembly and the metallic enclosure.

Implementations of the disclosure may include one or more of the following optional features. In some implementations, inserting the one or more fin inserts into the metallic enclosure includes attaching the one or more fin inserts to the electrode assembly such that the one or more fin inserts are inserted into the metallic enclosure together with the electrode assembly. In some examples, the cambered profile is selected so that so that the electrode assembly may be substantially uniformly cooled by at least one of a fluid or a gas flowing along the camber-flow battery cell. The method may also include nesting the camber-flow battery cell together with other camber-flow battery cells to form a battery array.

In some examples, forming the electrode assembly includes rolling the electrode material about a mandrel, wherein the mandrel has a shape corresponding to the cambered profile and applies a force to the electrode assembly to press the electrode assembly against the first and second side walls. Alternatively, forming the electrode assembly includes folding the electrode material back and forth on itself.

In some implementations, the one or more fin inserts are formed of a non-energy-storing thermally conductive material. In some examples, forming the metallic enclosure comprises welding the top cap plate and the bottom cap plate to each of the first and second side walls. Alternatively, forming the metallic enclosure includes forming the metallic enclosure as a single piece of material.

Yet another aspect of the disclosure provides a battery pack comprising a plurality of nested camber-flow battery cells, each camber-flow battery cell of the plurality of nested camber-flow battery cells including a metallic enclosure, an electrode assembly, and one or more fin inserts. The metallic enclosure includes a top cap plate, a bottom cap plate, a first side wall, and a second side wall, wherein the first and second side walls form a cambered profile defined by an imaginary chord line and an imaginary camber line, the imaginary camber line being different from the imaginary chord line. The electrode assembly is disposed within the metallic enclosure and includes a plurality of layers of an electrode material, wherein the plurality of layers of electrode material are formed by at least one of rolling the electrode material or folding the electrode material. Wherein each of the one or more fin inserts is fitted between the electrode assembly and the metallic enclosure to fill a respective space between the electrode assembly and the metallic enclosure.

### BRIEF DESCRIPTION OF THE DRAWINGS

The drawings described herein are for illustrative purposes only of selected configurations and are not intended to limit the scope of the present disclosure.

FIG. 1A is a partial exploded view of an example camber-flow battery cell.

FIG. 1B is a side view of the camber-flow battery cell of FIG. 1A with a side wall removed.

FIG. 1C is an isometric view of the camber-flow battery cell of FIG. 1A with a side wall and electrode assembly removed.

FIG. 1D is another isometric view of the camber-flow battery cell of FIG. 1A with a side wall, a bottom cap plate, and an electrode assembly removed.

FIG. 2 is an isometric view of another example camber-flow battery cell.

FIGS. 3A-3G illustrate example cambered profiles for camber-flow battery cells.

FIG. 4A is an illustration of an example battery array including a plurality of camber-flow battery cells.

FIG. 4B is an illustration of another example battery array including a plurality of camber-flow battery cells.

FIG. 5 is a flow chart of an example arrangement of operations for a method of forming a camber-flow battery cell.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Battery-powered devices (e.g., electric or hybrid-electric powered vehicles, or electric powered non-vehicular devices) are powered by one or more battery cells. In some instances, it is necessary to cool the battery cell(s) by flowing a fluid (e.g., a dielectric fluid or a thermally conductive fluid) or gas around the battery cell(s). However, the shape of some conventional battery cells may prevent a fluid or gas from uniformly flowing around the battery cell(s), which may result in local hots spots within the battery cell(s). Such hot spots may cause degraded energy storage or shorten the lifespan of a battery cell. Therefore, there is a need for battery cells having a profile that improves the flow of fluids or gasses around a battery cell. The present disclosure relates to camber-flow battery cells having a cambered profile that improves the flow of fluids or gasses around a battery cell. In particular, the cambered profile of a camber-flow battery cell provides a larger thermal contact area and a laminar flow shape that increase heat transfer from the camber-flow battery cell to a thermally conductive working or cooling fluid or gas. The cambered profile also reduces areas of turbulent flow or stagnation of the working or cooling fluid or gas by eliminating perpendicular surfaces and/or geometries that prevent or restrict fluid or gas flow. Disclosed camber-flow battery cells allow an electrode assembly within a battery cell to be substantially uniformly cooled by a fluid or gas flowing along the camber-flow battery cell. Moreover, disclosed camber-flow battery cells allow a plurality of camber-flow battery cells to be arranged or nested together in a battery array while allowing the battery cells to be uniformly cooled by a fluid or gas flowing through the battery array.

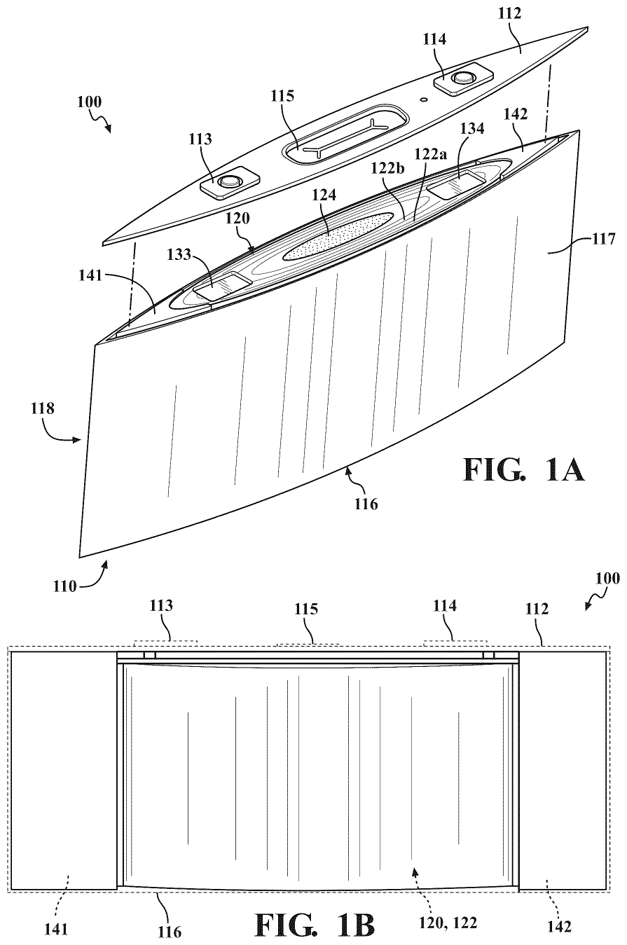

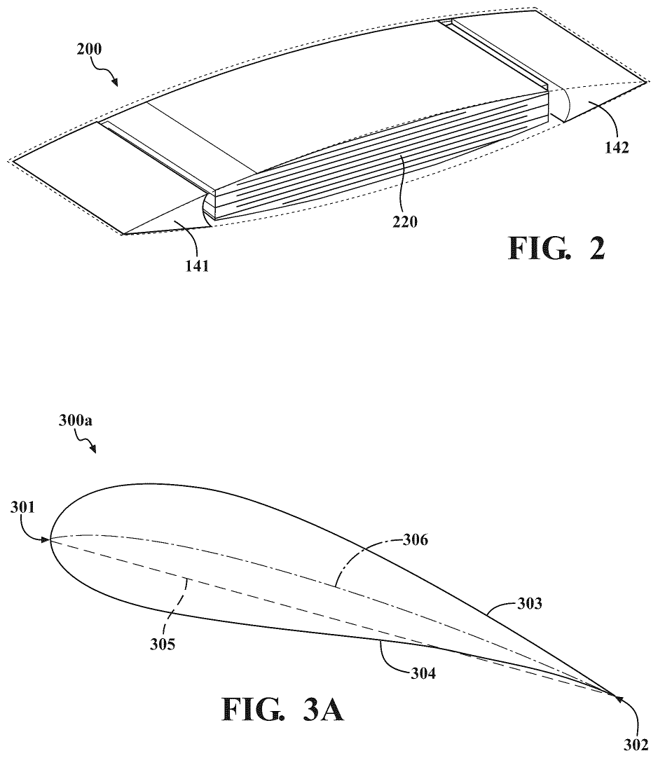

FIG. 1A is a partial exploded view of an example camber-flow battery cell 100. The camber-flow battery cell 100 includes a metallic enclosure 110 including a top cap plate 112, a bottom cap plate 116, a first side wall 117, and a second side wall 118. The first and second side walls 117, 118 form a cambered profile 300 defined by an imaginary chord line 310 and an imaginary camber line 312 that is different from the chord line 310 (see FIG. 3A).

In the illustrated example, the top cap plate 112 includes a positive terminal 113, a negative terminal 114, and a vent 115 disposed on the top cap plate 112. The vent 115 may, additionally or alternatively, be disposed on the bottom cap plate 116. In FIG. 1A, the top cap plate 112 has been removed to expose an electrode assembly 120 within the camber-flow battery cell 100, a first cell terminal collector 133 disposed in the electrode assembly 120, and a second cell terminal collector 134 disposed in the electrode assembly 120. When the top cap plate 112 is affixed to (e.g., welded to) the camber-flow battery cell 100, the positive terminal 113 is electrically connected to the first cell terminal collector 133, and the negative terminal 114 is electrically connected to the second cell terminal collector 134.

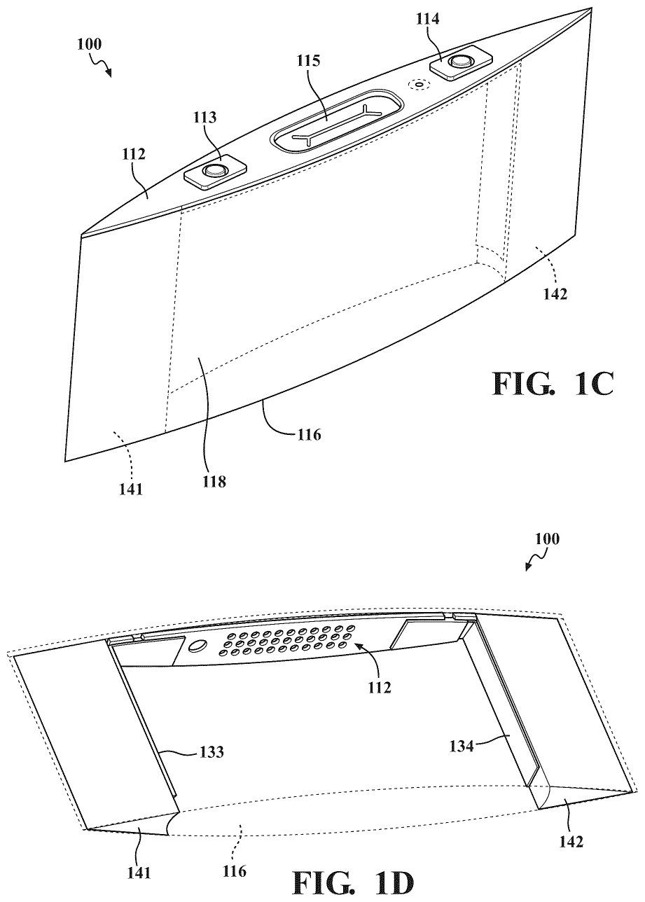

In the example of FIG. 1A, the electrode assembly 120 includes a plurality of layers 122, 122a-n of an electrode material made by rolling the electrode material around a mandrel 124. In some examples, the mandrel 124 has an elongated shape corresponding to the cambered profile of the camber-flow battery cell 100 formed by the side walls 117, 118, and applies a force to the electrode assembly 120 to press the electrode assembly 120 against the first and second side walls 117, 118. In some implementations, the mandrel 124 is omitted. Alternatively, as shown in FIG. 2, the electrode assembly 120 may be formed by folding an electrode material back and forth on itself.

In the illustrated example, the camber-flow battery cell 100 also includes one or more fin inserts 141 and 142 that are fitted between the electrode assembly 120 and the metallic enclosure 110 to fill respective spaces between the electrode assembly 120 and the metallic enclosure 110. In some examples, the fin inserts 141, 142 are fitted at respective ends of the metallic enclosure 110. In some implementations, the mandrel 124 and the fin inserts 141, 142 are formed from a non-energy-storing thermally conductive material. Example non-energy-storing thermally conductive materials include, but are not limited to, Al₂O₃ (Alumina), which may be used to improve the performance of the camber-flow battery cell 100 by scavenging HF in the camber-flow battery cell 100, Al(OH)₃, which may be used to absorb energy by endothermic reaction when exposed to temperatures above 200 degrees Celsius, or a blend of Al₂O₃ and Al(OH)₃.

FIG. 1B is a side view of the camber-flow battery cell 100 of FIG. 1A with the side wall 117 removed to expose the electrode assembly 120.

FIG. 1C is an isometric view of the camber-flow battery cell 100 of FIG. 1A with the side wall 117 and the electrode assembly 120 removed to expose the first and second cell terminal collectors 133, 134.

FIG. 1D is another isometric view of the camber-flow battery cell of FIG. 1 with the side wall 117 and the electrode assembly 120 removed to expose the bottom of the top cap plate 112 and the first and second cell terminal collectors 133, 134. FIG. 1D also shows the electrical coupling of the positive terminal 113 to the first cell terminal collector 133, and the negative terminal 114 to the second cell terminal collector 134.

FIG. 2 is an isometric view of another example camber-flow battery cell 200 with one of its side walls and bottom cap plate removed. In this example, layers of an electrode assembly 220 of the camber-flow battery cell 200 are formed by folding an electrode material back and forth on itself in a Z-stack pattern. As shown, the lengths of the folds or layers of the electrode material may vary across the electrode assembly 220 to form a particular electrode assembly profile.

In some implementations, the electrode material is folded back and forth on itself in a Z-stack pattern around a mandrel (not shown). An example mandrel has an elongated shape corresponding to a cambered profile formed by the side walls of the camber-flow battery cell 200 and applies a force to the electrode assembly 220 to press the electrode assembly 220 against the first and second side walls of the camber-flow battery cell 200. In some implementations, the mandrel is formed from a non-energy-storing thermally conductive material. Example non-energy-storing thermally conductive materials include, but are not limited to, Al₂O₃ (Alumina), which may be used to improve the performance of the camber-flow battery cell 200 by scavenging HF in the camber-flow battery cell 200, Al(OH)₃, which may be used to absorb energy by endothermic reaction when exposed to temperatures above 200 degrees Celsius, or a blend of Al₂O₃ and Al(OH)₃.

FIG. 3A is an illustration of an example cambered profile 300, 300a. As shown, the cambered profile 300a has a leading edge 301, a trailing edge 302, an upper surface 303, and a bottom surface 304. The cambered profile 300a is defined by an imaginary straight chord line 305 between the leading edge 301 and the trailing edge 302, and an imaginary curved camber line 306 that runs halfway between the upper and lower surfaces 303, 304 down the middle of the cambered profile 300a from the leading edge 301 to the trailing edge 302. The camber line 306 intersects the chord line 305 at the leading and trailing edges 301, 302. Between the leading and trailing edges 301, 302, the camber line 306 can curve above or below the chord line 305. The maximum distance between the camber line 306 and the chord line 305, measured perpendicular to the chord line 305 represents the amount of camber of the cambered profile 300a. In this example, the curved camber line 306 is different from the straight chord line 305.

FIG. 3B is an illustration of another example cambered profile 300, 300b. Here, the cambered profile 300b represents a symmetrical biconvex cambered profile, where its chord line and camber line overlap.

FIG. 3C is an illustration of yet another example cambered profile 300, 300c. Here, the cambered profile 300c represents an asymmetrical biconvex cambered profile, where its chord line and camber line are different.

FIG. 3D is an illustration of yet another example cambered profile 300, 300d. Here, the cambered profile 300d represents a flat-bottomed cambered profile, where its chord line and camber line are different.

FIG. 3E is an illustration of yet another example cambered profile 300, 300e. Here, the cambered profile 300e represents an under-cambered profile, where its chord line and camber line are different.

FIG. 3F is an illustration of yet another example cambered profile 300, 300f. Here, the cambered profile 300f represents a reflex or curved cambered profile, where its chord line and camber line are different.

FIG. 3G is an illustration of yet another example cambered profile 300, 300g. Here, the cambered profile 300g represents a supercritical-airfoil cambered profile, where its chord line and camber line are different.

While example cambered profiles 300 are shown in FIGS. 3A-3G, it should be understood that a camber-flow battery cell may be designed to have any cambered profile.

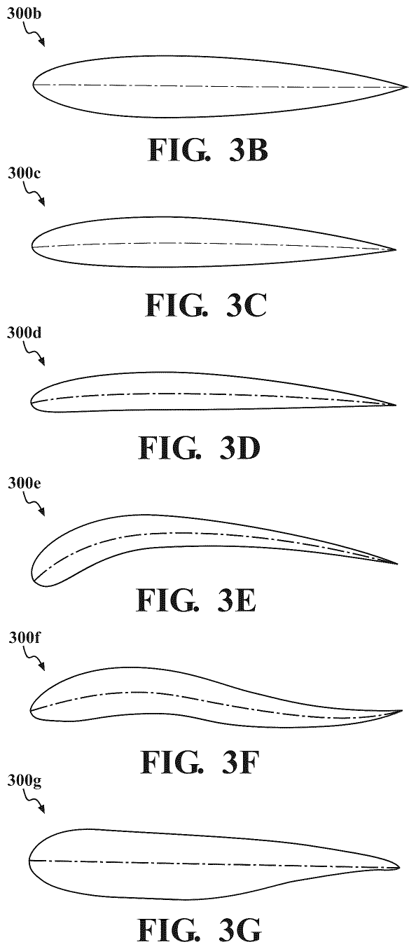

FIG. 4A is an illustration of an example battery array 400a including a plurality of camber-flow battery cells 410, 410a-n. Because of their cambered profiles, efficient and effective heat removal from the camber-flow battery cells 410 may be achieved by arranging or nesting the camber-flow battery cells 410 into an array and flowing a dielectric coolant or another thermally conductive fluid 420 through the battery array 400a and around the camber-flow battery cells 410. As illustrated, the cambered profiles of the camber-flow battery cells 410 create fluid flow paths that promote heat removal, a smooth laminar flow, and reduce pressure drop losses in the thermal fluid 420 throughout the battery array 400a.

FIG. 4B is an illustration of another example battery array 400b including a plurality of camber-flow battery cells 410. In this illustrated example, efficient and effective heat removal from the camber-flow battery cells 410 is achieved using cooling ribbons or manifolds 430, 430a-n made from, for example, thermal interface materials that are positioned in between the camber-flow battery cells 410. Because of their cambered profiles, the camber-flow battery cells 410 can be arranged or nested to increase cooling ribbon/manifold contact area with the side walls of the camber-flow battery cells 410. Here, the cambered profiles of the camber-flow battery cells 410 facilitate an efficient and effective cooling ribbon/manifold fluid channel geometry by, for example, eliminating sharp 90-degree bends and restricting heat flow pathways.

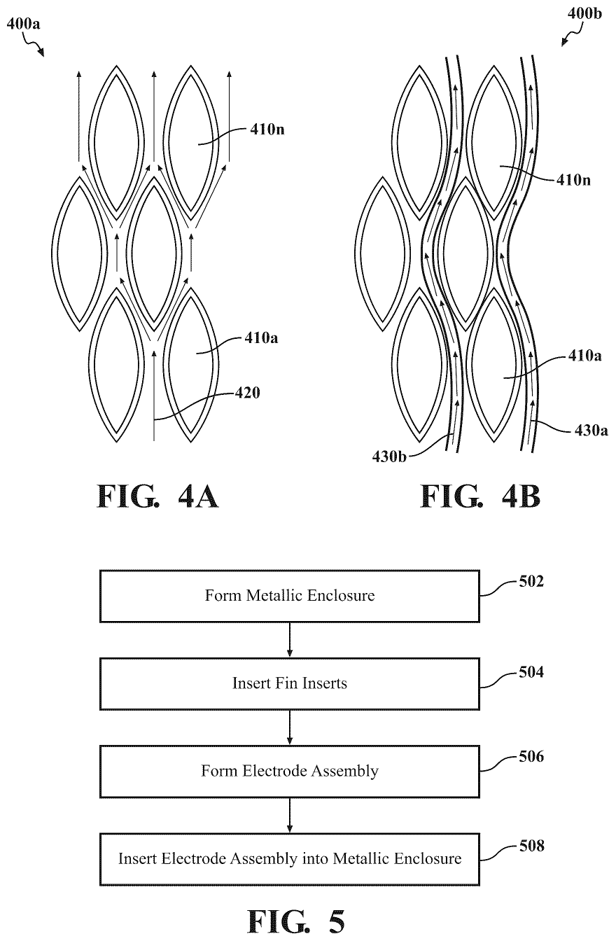

FIG. 5 is a flow chart of an example arrangement of operations for a method 500 of forming a camber-flow battery cell (e.g., the camber-flow battery cell 100 or camber-flow battery cell 200). The operations may be performed by data processing hardware based on executing instructions stored on memory hardware in communication with the data processing hardware.

At operation 502, the method 500 includes forming a metallic enclosure 110. The metallic enclosure 110 including a top cap plate 112, a bottom cap plate 116, a first side wall 117, and a second side wall 118. Here, the first and second side walls 117, 118 form a cambered profile defined by an imaginary chord line and an imaginary camber line, where the camber line is different from the chord line.

At operation 504, the method 500 includes inserting one or more fin inserts 141, 142 into the metallic enclosure 110. At operation 506, the method 500 includes forming an electrode assembly 120 by at least one of rolling an electrode material or folding the electrode material back and forth on itself. At operation 506, the method includes inserting the electrode assembly 120 into the metallic enclosure 110 between the one or more fin inserts 141, 142 and the first and second side walls 117, 118. Here, each of the one or more fin inserts 141, 142 fills a respective space between the electrode assembly 120 and the metallic enclosure 110.

In some implementations, inserting the one or more fin inserts 141, 142 into the metallic enclosure 110 includes attaching the one or more fin inserts 141, 142 to the electrode assembly 120 such that the one or more fin inserts 141, 142 are inserted into the metallic enclosure 110 together with the electrode assembly 120.

In some examples, the cambered profile is selected so that so that the electrode assembly 120 may be substantially uniformly cooled by at least one of a fluid or a gas flowing along the camber-flow battery cell. In some implementations, the operations further include nesting the camber-flow battery cell together with other camber-flow battery cells to form a battery array.

In some implementations, forming the electrode assembly 120 includes rolling the electrode material or folding the electrode material about a mandrel 124. Here, the mandrel 124 may have a shape corresponding to the cambered profile and applies a force to the electrode assembly 120 to press the electrode assembly 120 against the first and second side walls 117, 118.

In some implementations, the one or more fin inserts are formed of a non-energy-storing thermally conductive material. In some examples, forming the metallic enclosure 110 includes welding the top cap plate 112 and the bottom cap plate 116 to the first and second side walls 117, 118. In some examples, forming the metallic enclosure 110 includes forming the metallic enclosure 110 as a single piece of material.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A camber-flow battery cell comprising:
a metallic enclosure comprising:
a top cap plate;
a bottom cap plate;
a first side wall; and
a second side wall, wherein the first and second side walls form a cambered profile defined by an imaginary chord line and an imaginary camber line, the imaginary camber line being different from the imaginary chord line;
an electrode assembly disposed within the metallic enclosure and comprising a plurality of layers of an electrode material, wherein the plurality of layers of electrode material are formed by at least one of rolling the electrode material or folding the electrode material; and
one or more fin inserts, wherein each of the one or more fin inserts is fitted between the electrode assembly and the metallic enclosure to fill a respective space between the electrode assembly and the metallic enclosure.

2. The camber-flow battery cell of claim 1, wherein the cambered profile is selected so that the electrode assembly may be substantially uniformly cooled by at least one of a fluid or a gas flowing along the camber-flow battery cell.

3. The camber-flow battery cell of claim 1, wherein the cambered profile is selected so that the camber-flow battery cell may be nested together with other camber-flow battery cells to form a battery array.

4. The camber-flow battery cell of claim 1, further comprising a mandrel, wherein the mandrel has a shape corresponding to the cambered profile and applies a force to the electrode assembly to press the electrode assembly against the first and second side walls.

5. The camber-flow battery cell of claim 4, wherein the electrode material is rolled about the mandrel.

6. The camber-flow battery cell of claim 1, wherein the electrode material is folded back and forth on itself.

7. The camber-flow battery cell of claim 6, wherein lengths of folds of the electrode material vary across the electrode assembly.

8. The camber-flow battery cell of claim 1, wherein the one or more fin inserts are inserted at respective ends of the metallic enclosure.

9. The camber-flow battery cell of claim 1, wherein the one or more fin inserts are formed from a non-energy-storing thermally conductive material.

10. The camber-flow battery cell of claim 1, further comprising:
a first cell terminal collector disposed in the electrode assembly;
a second cell terminal collector disposed in the electrode assembly;
a positive terminal disposed on the top cap plate and electrically connected to the first cell terminal collector; and
a negative terminal disposed on the top cap plate and electrically connected to the second cell terminal collector.

11. The camber-flow battery cell of claim 1, further comprising a vent disposed on at least one of the top cap plate or the bottom cap plate.

12. A method for forming a camber-flow battery cell, the method comprising:
forming a metallic enclosure, the metallic enclosure comprising:
a top cap plate;
a bottom cap plate;
a first side wall; and
a second side wall, wherein the first and second side walls form a cambered profile defined by an imaginary chord line and an imaginary camber line, the imaginary camber line being different from the imaginary chord line;
inserting one or more fin inserts into the metallic enclosure;
forming an electrode assembly by at least one of rolling an electrode material or folding the electrode material; and
inserting the electrode assembly into the metallic enclosure between the one or more fin inserts and the first and second side walls, wherein each of the one or more fin inserts fills a respective space between the electrode assembly and the metallic enclosure.

13. The method of claim 12, wherein inserting the one or more fin inserts into the metallic enclosure comprises attaching the one or more fin inserts to the electrode assembly such that the one or more fin inserts are inserted into the metallic enclosure together with the electrode assembly.

14. The method of claim 12, wherein the cambered profile is selected so that so that the electrode assembly may be substantially uniformly cooled by at least one of a fluid or a gas flowing along the camber-flow battery cell.

15. The method of claim 12, further comprising nesting the camber-flow battery cell together with other camber-flow battery cells to form a battery array.

16. The method of claim 12, wherein forming the electrode assembly comprises rolling the electrode material about a mandrel, wherein the mandrel has a shape corresponding to the cambered profile and applies a force to the electrode assembly to press the electrode assembly against the first and second side walls.

17. The method of claim 12, wherein forming the electrode assembly comprises folding the electrode material back and forth on itself.

18. The method of claim 12, wherein the one or more fin inserts are formed of a non-energy-storing thermally conductive material.

19. The method of claim 12, wherein forming the metallic enclosure comprises at least one of:
welding the top cap plate and the bottom cap plate to each of the first and second side walls; or
forming the metallic enclosure comprises forming the metallic enclosure as a single piece of material.

20. A battery pack comprising a plurality of nested camber-flow battery cells, each camber-flow battery cell of the plurality of camber-flow battery cells comprising:
a metallic enclosure comprising:
a top cap plate;
a bottom cap plate;
a first side wall; and
a second side wall, wherein the first and second side walls form a cambered profile defined by an imaginary chord line and an imaginary camber line, the imaginary camber line being different from the imaginary chord line;
an electrode assembly disposed within the metallic enclosure and comprising a plurality of layers of an electrode material, wherein the plurality of layers of electrode material are formed by at least one of rolling the electrode material or folding the electrode material; and
one or more fin inserts, wherein each of the one or more fin inserts is fitted between the electrode assembly and the metallic enclosure to fill a respective space between the electrode assembly and the metallic enclosure.
